(19) United States
(12) Patent Application Publication
(10) Pub. No.: US 2009/0041096 A1
(43) Pub. Date: Feb. 12, 2009

(54) EFFICIENT SYNCHRONIZATION OF A SPREAD SPECTRUM SIGNAL IN THE PRESENCE OF DELAY AND FREQUENCY UNCERTAINTY

(75) Inventor: Cory S. Myers, Westford, MA (US)

Correspondence Address: Vern Maine & Associates, P. O. BOX 3445, NASHUA, NH, 03061, US

(73) Assignee: BAE SYSTEMS INFORMATION AND ELECTRONIC SYSTEMS INTEGRATION INC., Nashua, NH (US)

(21) Appl. No.: 11/832,736

(22) Filed: Aug. 2, 2007

(51) Int. Cl. H04B 1/707

(52) U.S. Cl. 375/150; 375/E01.002

(57) ABSTRACT

Implementations for the synchronization of a spread spectrum signal in the presence of delay and frequency uncertainty. According to one embodiment, there is a signal processing technique that combines coherent integration with a Fast Fourier Transform (FFT). Coherent integration with the direct sequence code is achieved through the use of shift registers, code modulators, and integrators, and applied to subsequences of the spreading code. Subsequences can then be combined via an FFT to achieve further coherent integration and to simultaneously deal with frequency uncertainty.

### STATEMENT OF GOVERNMENT INTEREST

Portions of the present invention have been made in conjunction with Government funding under Contract No. N41756-04-C-4211 and there may be certain rights to the Government.

### FIELD OF THE INVENTION

This present invention relates to advanced receiver techniques for processing signals, and according to one embodiment, to the synchronization of spread spectrum signals in the presence of delay and frequency uncertainty.

### BACKGROUND OF THE INVENTION

The use of spread-spectrum communications is ideal for many military applications because it uses wideband signals that are difficult to detect, hard to intercept, and resistant to jamming. Spread-spectrum communications has been around for many years and certain concepts were patented in 1942 and attributed to actress Hedy Lamarr (aka Hedy Kiesler Markey) and pianist George Antheil in U.S. Pat. No. 2,292,387 that described a secure radio link to control torpedoes.

More recently, the communications industry has made attempts at using spread spectrum processes for commercial purposes, especially in local area wireless networks. Due to the wide bandwidth, spread spectrum communications accommodates multiple users and tends to resist fading and multipath effects.

Spread spectrum generally relates to a form of communications in which the baseband signal bandwidth is spread over a larger bandwidth by spreading by a higher-bandwidth signal. Spread spectrum signaling is well-suited for difficult communications environments that have a low signal-to-noise (S/N) ratio caused by noise and interference. The transmission energy is spread over a wide bandwidth and the power level can be very low, including levels that are below the noise floor. The spreading and de-spreading typically involves a spreading code or spreading sequence associated with the communications channel that is used by the transmitter and receiver and in a typical spread spectrum operation, a spread spectrum code is injected in the transmitting chain to accommodate the spreading operation. At the receiver end, a de-spreading operation is performed to reconstitute the information in its original bandwidth.

Spread spectrum processing introduces additional communications options, especially in situation where the communications spectrum is limited, and some applications include, satellite-positioning systems (GPS), 3G mobile telecommunications, satellite communications, W-LAN (IEEE802.11a, IEEE802.11b, IEE802.11g), and Bluetooth.

There are several basic spread spectrum modulation techniques, including Direct Sequence Spread Spectrum (DSSS), Frequency Hopping Spread Spectrum (FHSS), and Time Hopping Spread Spectrum (THSS). Regardless of the modulation technique, there is some form of key, also known as code or sequence, coupled to the communication channel enabling the spreading and dispreading of the data.

Direct sequence spread spectrum takes a data sequence and, in the time domain, spreads the energy across a wide bandwidth. Upon transmission, the data signal is combined with a higher data-rate sequence called a spreading code, a spreading sequence or a chipping code.

In more particular detail, the direct sequence spread spectrum transmissions multiply the data being transmitted by a spreading signal. This spreading signal is typically a pseudorandom sequence of 1 and −1 values, at a bandwidth much higher than that of the original signal, thereby spreading the energy of the original signal into a much wider band. While a pseudorandom sequence of 1 and −1 is often used as a spreading sequence, other methods of spreading are known and the invention described herein is not restricted to spreading sequences that consist only of 1 and −1. In a spread spectrum system the information bits are spread by a sequence of faster chips wherein the chips refer to a continuous string of spreading code symbols that are modulated with the information bits. The chip rate is thus much higher than the information signal bit rate.

The resulting transmitted signal typically resembles noise but the noise-like aspects are filtered out at the receiving end to recover the original data, by multiplying the conjugate of the spreading sequence to the received signal. This process, known as “de-spreading”, mathematically constitutes a correlation of the transmitted PN sequence with the receiver's assumed sequence, wherein the transmit and the receive sequences must be synchronized in time and frequency.

The section in the receiver that extracts the desired signal is typically called a spread spectrum correlator. The correlator can be envisioned as a special type of matched filter, wherein the filter only responds to signals encoded with a code that matches its own code. The receiver can be tuned to another signal by changing the codes.

Processing of the spread spectrum demodulation has two main steps, namely de-spreading to remove the spectrum spreading modulation, and decoding the signal to extract its information content. De-spreading requires both timing and frequency synchronization of the spreading code between the transmitter and receiver in order to properly function.

The synchronization component has two main components, namely the initial acquisition of synchronization information and the tracking of the synchronization information. Synchronization information, is typically transmitted with the information content of the signal, and can be affected by distortion and interference. While there are several elements involved in synchronization, the timing and frequency estimates tends to play the dominant roles in synchronization since it is impossible to demodulate the underlying communications information if de-spreading is not accomplished and de-spreading cannot be accomplished unless the timing and frequency of the transmitted signal is determined.

The synchronization of the sequences of multiple transmitters allows the receivers to determine relative timing that is used to calculate the receiver's position which is used, for example, for satellite navigation. In addition, if an undesired transmitter transmits on the same channel but with a different PN sequence (or no sequence at all), the de-spreading process results in no processing gain for that signal which allows for code division multiple access (CDMA) that permits multiple transmitters to share the same channel. For operational efficiency, the optimal goal is to synchronize the received signal to the transmitted signal in order to achieve maximum coherent processing gain.

There have been efforts to determine the time-frequency distributions of energy in signals, and to develop systems and apparatus for measuring the energy in signals as a function of frequency and time. Signal processing has been used to achieve time-frequency distributions, or representations having high resolution with reduced interference from the effects of delay and frequency. Some embodiments include the use of Fourier transformation which is well known for decomposing a signal into its individual frequency components. Conventional Fourier analysis produces a representation of the frequency distribution of a signal without indicating the time at which the frequencies occurred.

As noted herein, one of the difficulties with direct sequence spread spectrum signal communications is that it is subject to various effects upon transmission, such as delay and frequency shift, and various uncertainties in transmitter timing and frequency. These effects make it difficult to easily synchronize the received signal to the transmitted signal. Current methods for synchronization with direct sequence spread spectrum signals are generally computationally complex or involve non-coherent integration that results in a significant loss of processing gain. For example, direct correlation with frequency search is computationally expensive and segmented filtering with non-coherent combining loses processing gain.

There have been several implementations that attempt to aid the receiver to properly acquire the desired signal. A training sequence is one such implementation and is a predetermined signal that is regularly sent as a sort of reference point. Thus, the receiver is set to expect that the training sequence has certain predetermined characteristics that are used to establish a priori transmission characteristics. If the receiver receives an uncorrupted training sequence, it can process the rest of the received signal portion without adjustments. However, if there is some deviation from what is expected in the training sequence, the receiver can be adjusted to correct for the error, thus ensuring that when the actual communication signal is sent, it is received without any problem.

Synchronization to direct sequence spread spectrum signals is particularly important in certain applications such as commercial terrestrial and satellite communication systems. Increasing data rates and high speed platform or user motion create situations with significant delay and frequency uncertainties with corresponding synchronization difficulties.

By way of illustration, the direct sequence spread spectrum process is performed by multiplying an RF carrier and a pseudo-noise (PN) digital signal. The PN code is modulated onto the information signal using one of several modulation techniques such as binary phase shift keying (BPSK) and quadrature phase shift keying (QPSK). A doubly balanced mixer is typically used to multiply the RF carrier and PN modulated information signal. This processing causes the RF signal to be replaced with a very wide bandwidth signal which is then amplified and transmitted. The wide bandwidth provided by the PN code allows for a low signal power that can be lower than the noise floor without any loss of information.

The demodulation process in the BPSK example involves mixing/multiplying of the same PN modulated carrier with the incoming RF signal and the receiver uses the same PN sequence to reconstruct the information signal, wherein the correlated signal is filtered and transmitted to a BPSK demodulator.

The growing demand for spread spectrum processing raises the need to optimize performance and provide an efficient signal processing system and processing to improve the quality and spectral efficiency of wireless communications and better techniques for sharing the limited bandwidth among different high capacity users

### SUMMARY OF THE INVENTION

A general embodiment of the invention is to provide implementations for the synchronization of a spread spectrum signal in the presence of delay and frequency uncertainty.

One embodiment is a sub-optimal spread spectrum detector for processing a received signal in the presence of delay and frequency uncertainty, comprising a shift register coupled to the received signal and separating the received signal into a plurality of samples. A multiplier coupled to the shift register is used for processing each of the samples with a spreading code to provide a set of de-spread outputs. There are a plurality of summing sections coupled to the de-spread outputs, wherein each of the summing sections has at least one of the de-spread outputs and wherein the summing sections output a set of summed outputs. A Fast Fourier Transform section is coupled to the summed outputs, wherein the Fast Fourier Transform section provides a set of correlated outputs. An energy detector is coupled to the correlated outputs.

The sub-optimal spread spectrum detector may include a processing section for extracting delay and frequency information from a set of energy detector outputs.

A further feature relates to a receiver front end coupled to the sub-optimal detector, wherein the front end can include an antenna, filter, amplifier, and mixer.

The spreading code according to one of the embodiments includes Barker, M-sequence, Gold, Kasami, and Hadamard-Walsh.

In addition, the Fast Fourier Transform includes zero padding.

A further feature is having the grouping determined by an acceptable loss parameter. The acceptable loss parameter in one embodiment is defined by the following:

$$Loss ( L , f ) = 10 {log}_{10} {\vert \frac{L sin ( \frac{π f}{{f}_{c}} )}{sin ( \frac{L π f}{{f}_{c}} )} \vert}^{2} dB$$

The samples in one embodiment are equal to N, the grouping is equal to L, and the set of correlated outputs from the FFT is equal to N/L.

One embodiment is a method for processing spread spectrum signals with delay and frequency shifting, comprising providing a received signal, separating the received signal into a plurality of samples, weighting the samples into weighted output values using spreading code information, grouping the weighted output values into grouped outputs, summing each of the grouped outputs into summed values to provide coherent gain, Fast Fourier Transforming of the summed values into correlated outputs to provide coherent gain, and detecting an energy response from each of the correlated outputs.

An additional feature is pruning of at least one of the summed values and the correlated outputs.

The method may include locating a largest energy response for each sample. In one embodiment, locating compares each energy response to a pre-defined threshold and can include repeating the steps until the largest energy response is found.

According to one embodiment, the invention is a system for processing received signals with delay and frequency shifting, comprising conditioning a received spread spectrum signal by a receiver front end, separating the received spread spectrum signal into a plurality of spreading code elements, performing a partial integration of the spreading code elements and producing a set of partially coherently integrated spreading code elements, processing the coherently integrated spreading code elements with a Fast Fourier Transform (FFT) to produce a set of coherently integrated outputs, and detecting an energy response of each of the coherently integrated outputs.

The step of separating can be performed in several manners, including using a tapped delay line or an analog delay line.

One feature of the partial integration involves despreading of the spread spectrum signal with a spreading code and summing the results into groups.

The spread spectrum signal can also be a structured code having a first code portion and a second code portion, and further including performing coherent integration of the first code portion and performing coherent integration of the second code portion.

The conditioning of the received spread spectrum signal includes conjugating the received spread spectrum signal.

A further aspect includes non-coherent integration of the set of coherently integrated outputs.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The present invention will be readily understood by the following detailed description in conjunction with the accompanying drawings, wherein like reference numerals designate like structural elements, and in which:

FIG. 1 shows a block diagrammatic presentation of a Direct Sequence Spread Spectrum transmitter and receiver configuration.

FIG. 2 is a prior art block diagrammatic perspective of an optimal detector with frequency compensation followed by cross-correlation.

FIG. 3 is a prior art block diagrammatic perspective of an optimal detector with a tapped delay-line followed by FFT in accordance with one embodiment of the present invention;

FIG. 4 is a prior art block diagram system of a sub-optimal detector with a segmented matched filter;

FIG. 5 illustrates an improved sub-optimal detector with a tapped delay-line and partial integration followed by FFT in accordance with one embodiment;

FIG. 6 illustrates a block diagram system of the present invention illustrating extensions in accordance with one embodiment.

FIG. 7 is a flowchart illustrating the sub-optimal detector processing according to one embodiment.

FIG. 8 illustrates one of several alternative implementations of processing illustrated in FIG. 5.

### DETAILED DESCRIPTION

The embodiments of the present invention disclosed herein enable implementations for the synchronization of a spread spectrum signal in the presence of delay and frequency uncertainty. These embodiments herein illustrate processing techniques applicable to many variations and applications all within the scope of the invention. According to one embodiment, there is a signal processing technique that combines coherent integration with a Fast Fourier Transform (FFT). Coherent integration with the direct sequence code can be achieved through the use of a shift register, code modulators, and integrators, and applied to subsequences of the spreading code. Coherent integration can also be achieved by alternative methods, such as filtering or frequency-domain processing using the FFT. Subsequences can then be combined via an FFT to achieve further coherent integration and to simultaneously deal with delay and frequency uncertainties.

By way of example, Direct Sequence Spread Spectrum (DSSS) signal is transmitted through a channel that induces an unknown delay and frequency shift due to Doppler. In many applications the combination of oscillator frequency uncertainty and Doppler frequency shift can be sufficiently large that it cannot be ignored in coherent processing. One goal is to synchronize the received signal to the transmitted signal with maximum coherent processing gain. While described in relation to DSSS, the present invention applies to other communications systems.

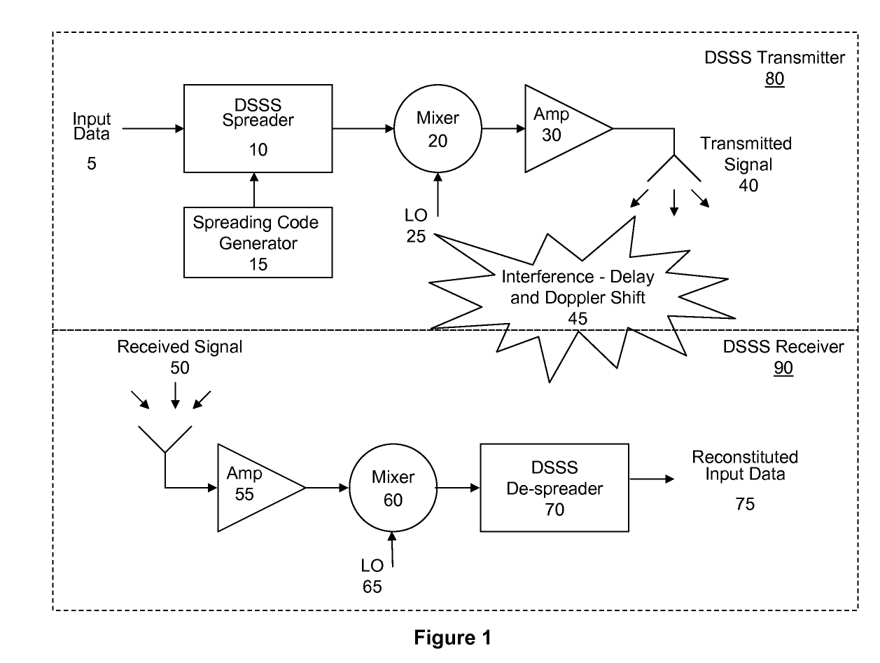

Referring to FIG. 1, the DSSS transmitter 80 and receiver 90 are illustrated according to one embodiment. The input data 5 represents the information signal that is being transmitted and ideally be reconstituted by the receiver section. The information bits are combined with the high bandwidth spreading code by the DSSS spreader 10 and the spreading code generator 15 and the signal is modulated with the mixer 20 to produce a high bandwidth signal that is amplified 30 and transmitted 40. The result of the modulation of an RF carrier with a code sequence is the DSSS signal with frequency spectrum centered at the carrier frequency. The transmitted signal s(n) is defined by the input bits b and a spreading sequence c₀, c₁, . . . c_{N-1} as follows:

s(n)=b_{floor(n/N)}c_{nmodN}

The spreading code is a priori information that is available to the transmitter and receiver for processing. The codes or pseudo random numbers (PRN) can employ some of the known code sequences such as Barker, Kasami, M-sequence, Gold, Hadamard-Walsh as well as many others. At the DSSS receiver 90, the received signal 50 arrives at the antenna and no longer is identical to the transmitted signal 40. Instead, the received signal 50 is a delayed and frequency shifted 45 version of the transmitted signal. Additionally, uncertainties in the transmitter timing and center frequency can be considered as a delay and as a frequency shift. The received signal can be mathematically described by (sampled at the chip rate):

r(n)=αe^{jωn}s(n−δ)

The received signal r(n) 50 is typically amplified and sometimes filtered before being lowered in frequency by a down-converter stage employing a mixer 60 with the corresponding local oscillator 65. The de-spreading of the signal is performed in the DSSS de-spreader 70 to obtain reconstituted transmitted information data 75 which is ideally the transmitted information data 5.

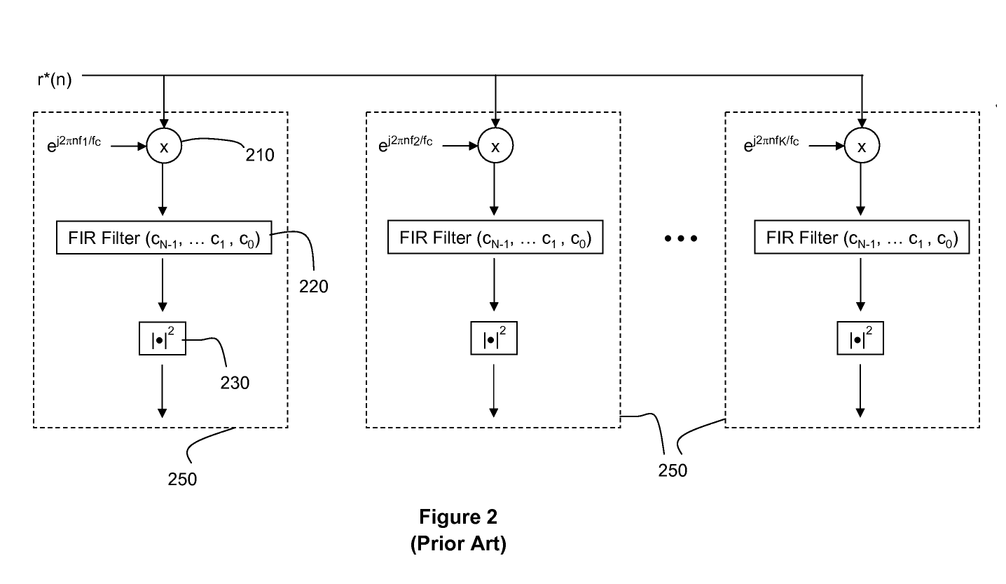

Referring to FIG. 2, a prior art optimal detector is depicted in which the receiver processing includes frequency compensation followed by cross-correlation. The receiver front end processing which may include antenna(s), amplifiers, filters and down-conversion stage(s) are not shown. The detector processes a spread spectrum signal that goes through a channel with uncertainties, and in particular, signals that have undergone some delay and frequency effect such that it is unknown when the signal is going to start or how much of the signal is frequency shifted.

The system takes the received signal such as time samples or analog signals, which are then modulated by carriers via the multipliers 210, wherein each of the carriers is a potential hypothesized frequency that is chosen to represent the uncertainty of the frequency shift. The a priori information is typically used to derive the hypothesized frequency carriers based on the knowledge of the geometry and particulars of the type of signal.

In the multiplier 210, the conjugate of the received signals are modulated by hypothesized frequency carriers to remove the frequency effects. We note that equivalent processing can be performed with this detector, as well as all the other detectors described herein, by not conjugating the received signal and, instead, by conjugating the modulation and the spreading-code. The resulting signal from the multiplier 210 is then subject to cross correlation, which in this embodiment is filtering with the spreading codes, wherein the FIR filter 220 is a function of the direct sequence spreading.

The energy is then measured over time 230 wherein one of the signals should have a stronger response over time. The location of this stronger response represents the delay and the channel that it resides in indicates the frequency.

In more particular detail, the received signal r(n) includes the delay and frequency shift along with the information input data sampled at the chip rate and is expressed as:

$$r ( n ) = {αe}^{jω n} s ( n - δ )$$

As indicated, the entire process for a single frequency 250 corresponds to the input signal r(n) being cross correlated with all possible delay and frequency shifted code sequences and processed for the one with the largest response.

The energy function statistic as measured by the energy detectors 230, for a single bit interval, is given by:

$$D ( δ , f ) = {\vert {\sum }_{n = 0}^{N - 1} {e}^{\frac{j 2 π nf}{{f}_{c}}} {c}_{n} {r}^{*} ( n + δ ) \vert}^{2}$$

The coherent gain is 10log₁₀(N) where N is the number of chips being coherently combined. The extension to a known sequence of bits is straight-forward. Additional non-coherent processing gain can be generated for the case of unknown bits by following the coherent processing with non-coherent integration. The additional non-coherent gain is 5log₁₀(K) where K is the number of terms being non-coherently combined.

With respect to parameter selection, the frequency spacing depends on the maximum allowed mismatch loss. The loss is given by:

$$Loss ( f ) = 10 {log}_{10} {\vert \frac{N sin ( \frac{πΔ f}{2 {f}_{c}} )}{sin ( \frac{N πΔ f}{2 {f}_{c}} )} \vert}^{2} dB$$

This loss is an indication of the signal to noise ratio (SNR) for the difference between each frequency path.

The number of frequencies to be processed (K) depends on the range of frequency uncertainty and is represented as follows:

$$K = \frac{{f}_{Max} - {f}_{Min}}{Δ f}$$

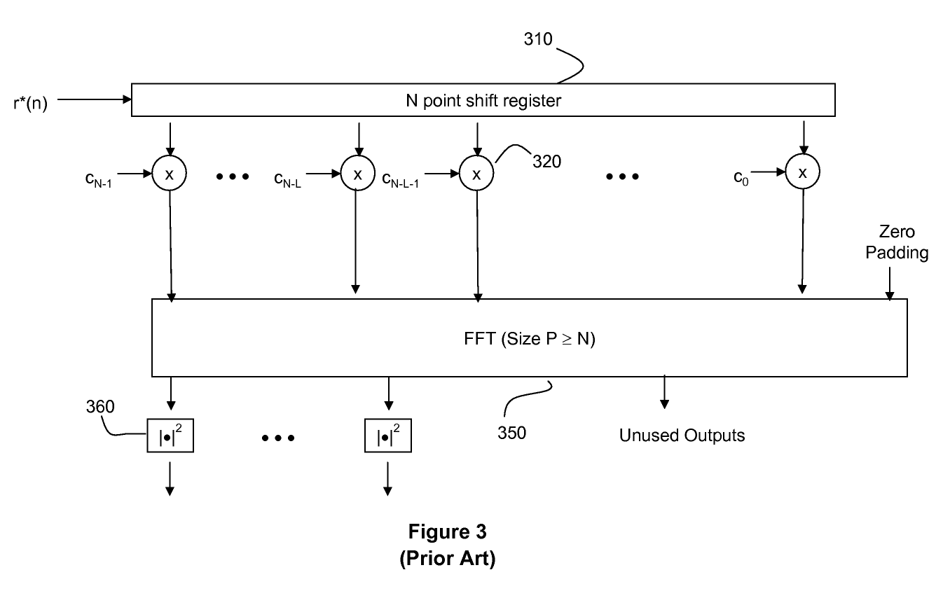

Referring to FIG. 3, another prior art optimal detector configuration is depicted having a tapped delay line followed by FFT processing. The conjugate of the received signal r(n) is an input to the N point shift register 310 which can be a tapped delay line in a digital case and an analog delay line in an analog case. The input signal r(n) can also be used with the conjugate of the code. The sequence is multiplied by the spreading code at each multiplier 320 with a different spreading code coefficient for each multiplier 320.

The output of the multiplier stage 320 is a signal that has been scaled by the spreading code and is then input to a size P FFT function 350 that performs an FFT processing of the summed signal.

With respect to parameter selection for this embodiment, the FFT size depends on the frequency spacing desired based on the acceptable loss:

$$Δ f = \frac{{f}_{c}}{P}$$

This is essentially another method of implementing the prior art FIG. 2 embodiment and both are mathematically identical. Zero padding in the FFT function 350 relates to the addition of zeros since the FFT has natural sizes such as powers of two and if the input to the FFT is not the same size, zeros are added. The FFT size needs to be at least as big as the code length, e.g. P≧N.

There is a range of frequencies and each output of the FFT 350 corresponds to a different frequency shift; however some may be disregarded based on the a priori information. The number of bins that are looked at depends on the range of frequency uncertainty. Note that a pruned FFT both on the input and on the output is a further variation. Pruning refers to the fact that if you know some of the inputs of an FFT are a zero or if some output can be ignored based on a priori information, this allows for a simpler FFT by changing the hardware or software implantation which is well known in signal processing.

The output from the FFT 350 is introduced to a set of energy detectors 360 that measure the energy of the output of the FFT. The processing shift one time sample and the process is repeated for the next energy measurement.

In more particular detail, the conjugate of the received signal r(n) is coupled to an N point shift register 310 separating the received signal into N samples. Each input sequence sample has a multiplier 320 which introduces scaling by the spreading code elements c₀, c₁, . . . c_{N-1}. The resulting output of the multipliers 320 are the inputs to a size P FFT 350 which is used to cross correlate the signals. The output of the FFT 350 is then processed by energy detectors 360 using the energy detection processing as previously noted and the measured outputs are provided for further processing to locate the largest energy signal. The system shifts one time sample and the processing repeats.

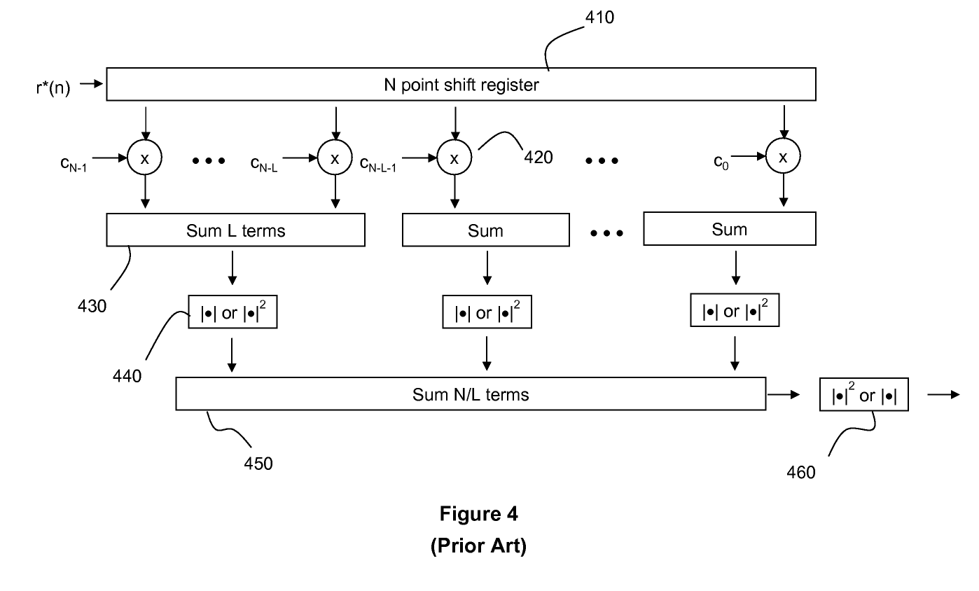

Another prior art configuration of a sub-optimal detector is shown in FIG. 4, which is a Segmented Matched Filter that breaks the spreading code into segments, each of which filters the code, and then non-coherently combines the segments. Such an implementation by B. Persson and D. E. Dodds, J. E. Salt, R.J. Bolton, is described in “CDMA Code Synchronization Using Segmented Matched Filter with Accumulation and Best Match Selection”, Proceedings of IEEE Military Communications Conference (MILCOM), Oct. 7-10, 2002, Anaheim, Calif., Session U505, Vol. 2, pp. 976-981.

The parameter selection for this sub optimal detector segmented matched filter behaves like a coherent integrator of length L (L>1) (with a small additional loss) followed by non-coherent integration. Each doubling of L adds 1.5 dB of processing gain. This is a form of approximation based on the frequency and loss.

In some respects, the operation is similar to those previously described, wherein the conjugate of a received signal r(n) is processed by a shift register 410. The output from the shift register is subject to a multiplier 420 that modulates the signal with the respective spreading code entry. The outputs from the multiplier 420 are grouped and summed together in a summer of L terms 430. Grouping is typically based on characteristics such as loss as a function of L, wherein the design criteria determine an operational parameter of the amount of loss that will still allow adequate processing. By way of illustration, a smaller L translates to less loss while a higher L translates to less computation. With larger frequency uncertainty, the loss gets very large.

The output from the each summer 430 is the input to the corresponding energy detectors 440 that measure the energy or the energy squared. The output of the energy detectors 440 is subject to a summation of N/L terms of all the energy detector outputs. This process adds all the groups of energy to derive the detection statistic wherein N items are and summed in groups of L, so there are N/L lines or inputs for the detection statistic. Every time it is shifted as a time sample only one output in time will indicate delay. No indication of the frequency shift is provided. Output from the summer 450 is processed by a second energy detector 460 to produce the energy level. In one embodiment the energy detector takes the absolute value and squares the result. As this sub-optimal approach does not coherently integrate over the entire spreading sequence it incurs a loss of 5log₁₀(N/L) dB compared to coherently integrating over the entire spreading sequence. This loss drives a desire to make L as large as possible but there is an additional loss due to frequency uncertainty.

The number of terms to sum for the grouping depends on the additional loss that can be tolerated. Note that the addition loss is frequency dependent and grows as L gets large. Note also that the additional loss also depends on the chip rate of the spreading sequence, f_{c}. Table A provides an indication of the additional loss.

$$Loss ( L , f ) = 10 {log}_{10} {\vert \frac{L sin ( \frac{π f}{{f}_{c}} )}{sin ( \frac{L π f}{{f}_{c}} )} \vert}^{2} d B$$

TABLE A

| Loss(L, f) | | L | | | | | |
|---|---|---|---|---|---|---|---|
| (dB) | | 2 | 4 | 8 | 16 | 32 | 64 |
| f/f_{c} | 1/100 | 0.0043 | 0.0214 | 0.0902 | 0.3675 | 1.5143 | 6.9339 |
| | 1/10 | 0.4359 | 2.2767 | 12.4771 | N/A* | N/A* | N/A* |

*Lf/f_{c} ≧ 1 implies there is a frequency with infinite loss

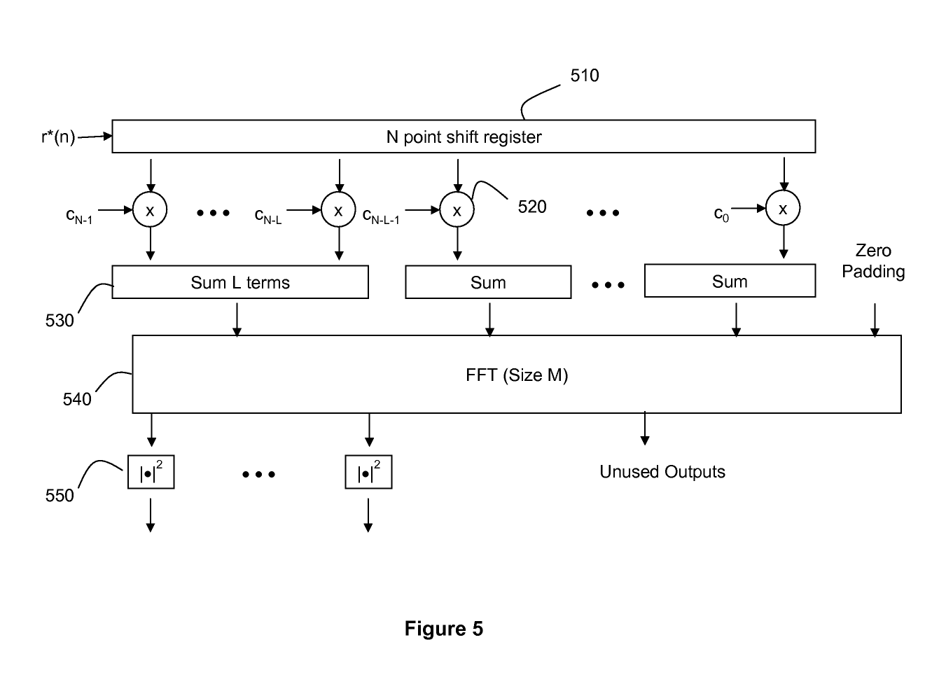

FIG. 5 shows one embodiment for an improved sub-optimal detector. This embodiment uses a shift register such as a tapped delay line with partial integration followed by FFT. As previously indicated with respect to the parameter selection, the FFT size depends on the frequency spacing desired based on the acceptable loss

$$Δ f = \frac{{f}_{c}}{LM}$$

As already described, the conjugate of the received signal r(n) is subject to an N point shift register 510 that takes the output at every time step and separates the received signal into N samples. A multiplier 520 processes the samples and multiplies the output from the shift register by spreading codes coefficients to produce de-spread outputs. As used herein, de-spread is taken in a broad context. The de-spread outputs from the multipliers 520 are subject to a summation by a number of sum sections 530 that sums the de-spread outputs in groups of L (L>1).

Instead of measuring the energy out of each group as shown in FIG. 4, the group summed terms are fed it into an FFT section 540 and the individual correlated outputs out of the FFT are the processed by energy detectors 550 that look at the energy at each of the FFT correlated outputs.

In operation, the largest level output is selected for post processing to extract the delay and frequency information. For every time shift sample, a new FFT output is obtained, wherein the individual elements of the FFT output correspond to a different frequency shift.

Advantages to this system include at least the following, namely the FFT is much smaller as compared to the optimal detection schemes in FIG. 2 and FIG. 3, and this system maintains coherent gain over the entire chip sequence, recovering 5log₁₀(N/L) dB of gain compared to the sub-optimal method. In distinction to the sub-optimal detector of FIG. 4, this system is able to detect individual frequency information and without loss term.

The FFT size needs to be at least as big as the number of segments, e.g. M≧(N/L). The number of bins that are looked at depends on the range of frequency uncertainty. Note that one can use a pruned FFT both on input and output. The unused outputs can be determined from a priori information to lower the processing time and computational complexity.

Compared to the sub-optimal approach, this approach fully recovers the coherent processing gain but still incurs the small additional loss term. Note that the loss is frequency dependent. The number of terms to group, such as L terms, depends on the additional loss that can be tolerated and one embodiment provides for grouping as follows:

$$Loss ( L , f ) = 10 {log}_{10} {\vert \frac{L sin ( \frac{π f}{{f}_{c}} )}{sin ( \frac{L π f}{{f}_{c}} )} \vert}^{2} dB$$

The grouping of the de-spread signals from the multipliers 520 can include an equal number of de-spread signals for each group which is then processed by the FFT. In another embodiment the number of de-spread signals within the groups can be different. In the case having different number of de-spread signals, the FFT processing in one embodiment is modified and the loss term will be modified.

According to one simulation, the parameters are as follows: Chip rate of 1 MHz; Frequency uncertainty is ±10 KHz; Code duration is 1024 chips. With L=32 the additional loss, at the highest frequency uncertainty, would be 1.5 dB and would reduce the FFT size from 1024 points to 32 points. Table B provides a comparison of the processing gain and computation cost of the alternative methods.

TABLE B
Comparison of Methods

| | Computational | Processing Gain per |
|---|---|---|
| Method | Cost per Sample | Bit |
| Frequency | O(NK) | 10log10N − Loss(Δf) |
| Compensate with | | |
| Cross-Correlation | | |
| FIG. 2 | | |
| Tapped Delay Line | O(N) + O(Plog₂P) | 10log10N − Loss(Δf) |
| with FFT | | |
| FIG. 3 | | |
| Segmented Matched | O(N) | 10log10N − Loss(Δf) − |
| Filtering | | 5log10(N/L) − Loss(L,f) |
| FIG. 4 | | |
| Proposed Approach | O(N) + O(Mlog₂M) | 10log10N − Loss(Δf) − |
| FIG. 5 | | Loss(L,f) |

An illustrative Example is as follows: Example: Chip rate of 1 MHz. Frequency uncertainty is ±10 KHz. Code duration is 1024 chips. Pick Δf=1 KHz for Loss (Δf)=3.9 dB. Implies that tapped delay line with FFT uses P=1024 and only examines 21 of the output FFT bins. Pick L=32 for Loss (L, 10 KHz)=1.5dB. The proposed approach uses M=32 and still examines only 21 of the FFT bins and achieves a 7.5 dB processing gain compared to Segmented Matched Filter. Thus, the additional cost compared to the sub-optimal detector is the cost of a 32 point FFT but the additional processing gain is 7.5 dB. Compared to an optimal detector, the processing loss is only 1.5 dB but the computational savings is replacing a 1024 point FFT with a 32 point FFT, a significant reduction in computational cost.

The computational cost per sample is an indication of the amount of computer power required for processing. Every time a new sample is taken, a certain amount of processing required and this number provides a mechanism to assess the computer power processing. The proposed approach is only slightly more complex but gains back 7.5 dB in loss.

TABLE C
Theoretical data based on simulations

| | | Processing Gain |
|---|---|---|
| | Computational Cost | per Bit |
| Method | per Sample | (Worst Case) |
| Frequency | O(21*1024) | 26.2 dB |
| Compensate with | | |
| Cross-Correlation | | |
| (FIG. 2) | | |
| Tapped Delay Line | O(1024) + | 26.2 dB |
| with FFT | O(10*1024) | |
| (FIG. 3) | | |
| Segmented | O(1024) | 17.2 dB |
| Matched Filtering | | |
| (FIG. 4) | | |
| Proposed | O(1024) + | 24.7 dB |
| Approach | O(5*32) | |
| (FIG. 5) | | |

As noted in Table C, the proposed approach significantly reduces cost compared to optimal methods at minimal loss of processing gain. The system recovers gain as compared to Segmented Matched Filter with minimal additional computational cost.

It should be clear to one skilled in the art of spreading codes that the proposed method can also be tailored to structured spreading codes that are built up out of smaller spreading codes. For instance, sometimes the manner in which users create sequences of spreading codes is to interweave spreading codes. For example, assume a simple example of a four element first spreading code of +1−1+1−1 and another three element spreading code of +1−1+1. These codes can be combined to form a hybrid new code of 12 elements long +1−1+1−1+1−1+1−1+1−1+1−1.

Note that if the code is some form of structured code such as a repeating code or a factored code of some type, the code can be represented as:

$${c}_{n} = {c}_{n mod {N}_{1}}^{( 1 )} {c}_{\frac{( n - n mod {N}_{1} )}{{N}_{1}}}^{( 2 )}$$

The process can thus repeat the structure. In more specific detail of this embodiment, assuming that the system processes the first code (Code 1), rather than performing non-coherent integration of subsequent codes, it performs coherent integration using the second code (Code 2)but with the taps in the shift register spaced by N₁ taps.

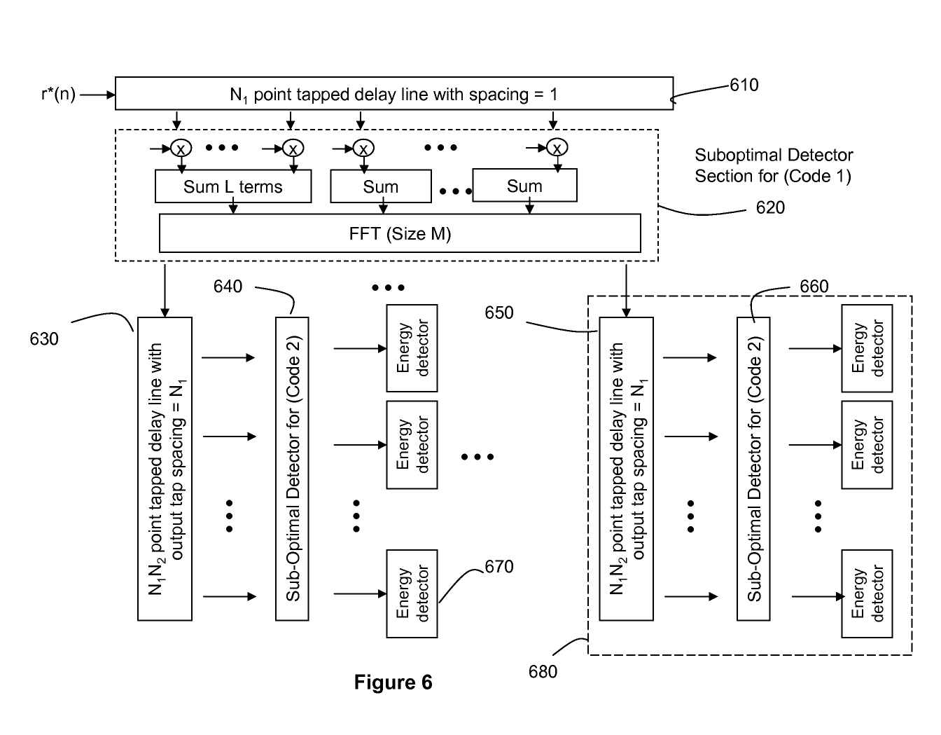

A block diagram showing extensions according to one embodiment is shown in FIG. 6. Here the conjugate of a received signal r(n) is provided as the input to the N₁ point shift register 610 which in this example is an N₁ point tapped delay line with spacing=1. The outputs from the shift register 610 is input to the sub-optimal detector section 620 which is essentially a portion of the detector system from FIG. 5 including the multiplier, 520, sum section 530, and FFT 540 but without the energy detectors.

The outputs from the sub-optimal detector section 620 are then inputs to additional sub-optimal detectors 680, wherein the sub-optimal detectors include a shift register 630, multiplier (not shown), sum section (not shown), FFT (not shown) and energy detectors 670. In more detail, the output from the FFT section of the Sub-optimal detector section 620 is output to the N point shift registers 630, 650 such as N₁N₂ point tapped delay lines with output tap spacing=N₁. The outputs from the shift register 630, 650 are then input to additional sub-optimal detector sections 640 for Code 2. The Sub-optimal detector sections includes the multiplier (not shown), shift register (not shown), multiplier (not shown), sum section (not shown), FFT (not shown). The outputs from the sub-optimal detector section 640 are then processed by energy detectors 670.

By way of illustration, assume Code 1 is a two chip code +1,−1. This effectively means using Manchester encoding for the long PN code which introduces a poor auto-correlation effect at one chip offset. According to one example, if the outer code is a perfect code then the resulting code has an autocorrelation function at ±1 chip offset that is −½ times the height of the autocorrelation peak at zero.

Unless the frequency uncertainty is very large, the sub-optimal first stage will simply become a two point FIR filter. In this example, the FFT size is one half of what it would have been otherwise.

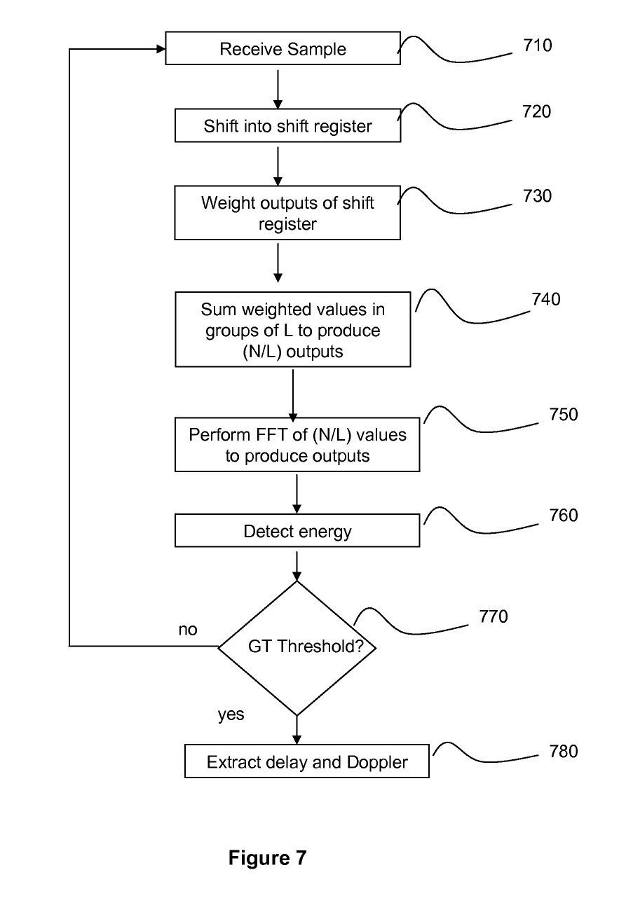

Referring to FIG. 7, a process flow according to one embodiment is depicted. The process commences with a received signal sample r(n) and a set of N−1 previously received samples 710. The received signal sample is shifted and placed into digital or analog shift register 720. There are certain weights applied to the shift register outputs 730 by spreading codes depending upon a priori information. The weighted values are then processed by summing weighted values into groups of L to produce (N/L) outputs 740. The N/L outputs are then subject to an M point FFT processing to generate cross correlated outputs. This may include the optional zero padding as detailed herein 750.

The energy levels are then detected for the various outputs 760. In one embodiment the largest energy response indicates the signal of interest and the delay and frequency shift are extracted. The processing for the largest response can be done in a number of ways, including comparing the detected energy to a certain predetermined threshold and if the threshold level is exceeded, it indicates the largest signal has been located and the delay and frequency components are extracted 780. Alternatively, all the energy responses can be sorted and the largest value selected. The extracted results can be subject to post-processing or provided to the end-user for evaluation.

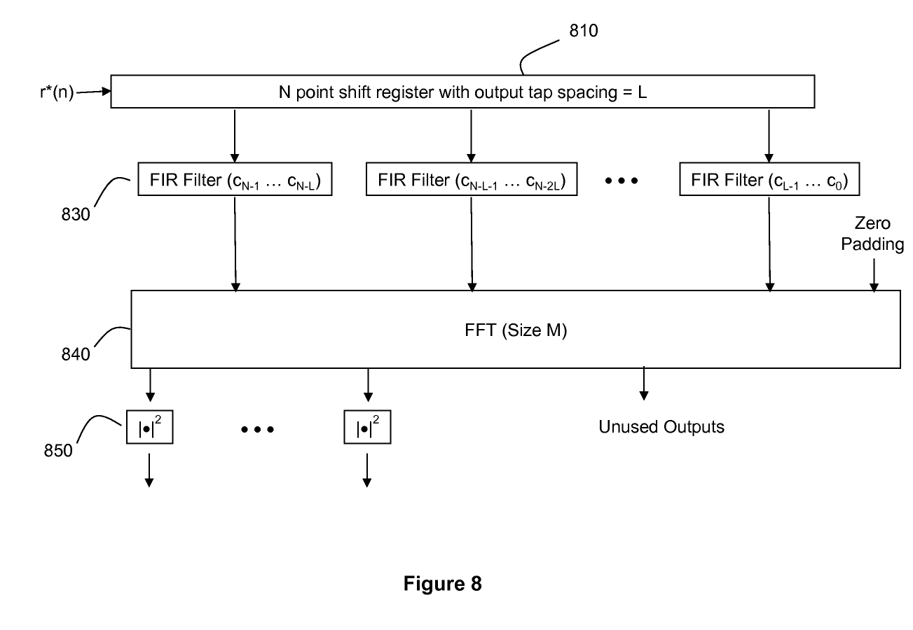

Alternative embodiments of the invention exist in which the coherent integration with subsequences of the spreading code can be achieved in other ways and the coherent processing of the FFT can be achieved in other ways. One such alternative embodiment of the invention is shown in FIG. 8. In this embodiment the conjugate of the input signal is shifted into a tapped delay line 810 of length N whose output taps are spaced by L samples. Each output tap is then fed into a different FIR filter 830, each of which is programmed with a different L chip subsequence of the spreading sequence. The outputs of the FIR filters 830 are then fed into an M point FFT 840 whose outputs are processed by energy detectors 850.

According to one embodiment, the signal processing combines coherent integration with a Fast Fourier Transform (FFT). Coherent integration with the direct sequence code is achieved through the use of such elements as shift registers, code modulators, and integrators, and applied to subsequences of the spreading code. Subsequences can then be combined via the FFT to achieve further coherent integration and to simultaneously deal with frequency uncertainty.

The foregoing descriptions of the embodiments of the invention have been presented for the purposes of illustration and description. These descriptions are not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A sub-optimal spread spectrum detector for processing a received signal in the presence of delay and frequency uncertainty, comprising:
a shift register coupled to said received signal and separating said received signal into a plurality of samples;
a multiplier coupled to said shift register and processing each of said samples with a spreading code to provide a set of de-spread outputs;
a plurality of summing sections coupled to said de-spread outputs, wherein each of said summing sections has at least one of said de-spread outputs and wherein said summing sections output a set of summed outputs;
a Fast Fourier Transform section coupled to said summed outputs, said Fast Fourier Transform section providing a set of correlated outputs; and
an energy detector coupled to said correlated outputs.

2. The detector according to claim 1, further comprising a processing section for extracting delay and frequency information from a set of energy detector outputs.

3. The detector according to claim 1, further comprising a receiver front end coupled to said sub-optimal detector, wherein said front end is at least one of the group consisting of: antenna, filter, amplifier, and mixer.

4. The detector according to claim 1, wherein the spreading code is selected from the group consisting of: Barker, M-sequence, Gold, Kasami, and Hadamard-Walsh.

5. The detector according to claim 1, wherein the Fast Fourier Transform includes zero padding.

6. The detector according to claim 1, wherein the grouping is determined by an acceptable loss parameter.

7. The detector according to claim 6, wherein the acceptable loss parameter is defined by the following:
$$Loss ( L , f ) = 10 {log}_{10} {\vert \frac{L sin ( \frac{π f}{{f}_{c}} )}{sin ( \frac{L π f}{{f}_{c}} )} \vert}^{2} dB$$

8. The detector according to claim 1, wherein the samples are equal to N, the grouping is equal to L, and said set of correlated outputs from said Fast Fourier Transform section is equal to N/L.

9. A method for processing spread spectrum signals with delay and frequency shifting, comprising:
providing a received signal;
separating said received signal into a plurality of samples;
weighting said samples into weighted output values using spreading code information;
grouping said weighted output values into grouped outputs;
summing each of said grouped outputs into summed values to provide coherent gain;
Fast Fourier Transforming of said summed values into correlated outputs to provide coherent gain; and
detecting an energy response from each of said correlated outputs.

10. The method according to claim 9, wherein the samples is equal to N, the grouping is equal to L, and said set of correlated outputs from said Fast Fourier Transforming is equal to N/L.

11. The method according to claim 9, further comprising a pruning of at least one of said summed values and said correlated outputs.

12. The method according to claim 9, further comprising locating a largest energy response for each said sample.

13. The method according to claim 12, wherein said locating compares each said energy response to a pre-defined threshold.

14. The method according to claim 12, wherein said locating compares each said energy response to a pre-defined threshold and repeating said steps until said largest energy response is found.

15. A system for processing received signals with delay and frequency shifting, comprising:
conditioning a received spread spectrum signal by a receiver front end;
separating said received spread spectrum signal into a plurality of spreading code elements;
performing a partial integration of said spreading code elements and producing a set of partially coherently integrated spreading code elements;
processing said coherently integrated spreading code elements with a Fast Fourier Transform (FFT) to produce a set of coherently integrated outputs; and
detecting an energy response of each of said coherently integrated outputs.

16. The system according to claim 15, wherein said separating is performed by a tapped delay line or an analog delay line.

17. The system according to claim 15, wherein said partial integration comprises despreading said spread spectrum signal with a spreading code and summing said results into groups.

18. The system according to claim 15, wherein said spread spectrum signal is a structured code having a first code portion and a second code portion, further comprising performing coherent integration of said first code portion and performing coherent integration of said second code portion.

19. The system according to claim 15, wherein said conditioning of said received spread spectrum signal includes conjugating said received spread spectrum signal.

20. The system according to claim 15, further comprising non-coherent integration of said set of coherently integrated outputs.
